(19) United States
(12) Patent Application Publication
(10) Pub. No.: US 2023/0282076 A1
(43) Pub. Date: Sep. 7, 2023

(54) Solitaire Game For A Monetary Reward

(71) Applicant: Phillip H. Bryant, SR., Little Rock, AR (US)

(72) Inventor: Phillip H. Bryant, SR., Little Rock, AR (US)

(21) Appl. No.: 17/687,870

(22) Filed: Mar. 7, 2022

(51) Int. Cl. G07F 17/32

(52) U.S. Cl. CPC G07F 17/3293; G07F 17/3244

(57) ABSTRACT

The present invention is directed to a method and a system for playing solitaire for monetary reward. One game consists of multiple hands played by multiple players. Multiple players play solitaire hands on randomized layouts which the players can choose to play on or pass and play a different randomized layout up to a certain number of times. Money is distributed based on the number of cards a player has left in a stack and tableau compared to the number of cards other players have left. Points are distributed to the players based on their ranks in the game. Bonus points and money are received for every true solitaire. Money is paid into a lottery pool for distribution to the top players after a certain criterion such as but not limited to time, money in the lottery pool, or number of games is met. Solitaire for a monetary reward offers three ways of winning money. Players can win money by having the lowest total cards, winning a true solitaire with no cards remaining in a stack and tableau, or winning a percentage or a flat amount out of a lottery pool.

### TECHNICAL FIELD

The present invention relates generally to the field of card play and more specifically to a method and system of playing solitaire with multiple players playing on their own foundations for monetary reward.

### BACKGROUND

The following is a tabulation of some prior art that presently appears relevant:

U.S. Patents

| Patent Number | Kind Code | Issue Date | Patentee |
|---|---|---|---|
| U.S. Pat. No. 6,077,161 | A | Jun. 20, 2000 | Wisler |
| U.S. Pat. No. 6,283,855 | B1 | Sep. 4, 2001 | Bingham |
| U.S. Pat. No. 9,039,506 | B1 | May 26, 2015 | Schmitt |

U.S. Patent Application Publications

| Publication Nr. | Kind Code | Publ. Date | Applicant |
|---|---|---|---|
| US 2013/0310154 | A1 | Nov. 21, 2013 | Sparago |
| WO 2014/037813 | A3 | Mar. 13, 2014 | Uhren, et al. |

Solitaire as a game of chance is well known in the prior art. Casinos and gambling are likewise popular. Gaming is a growing industry and there is a continuing need for new games for players to enjoy and play. With games such as slot machine layouts, the player must accept the first layout they get. Poker hands must be played as they are dealt. Blackjack hands must also be played as they are dealt. Players do not get to control which layout they are dealt.

True solitaire is well known as a game that is played by one player alone. Variations can be found where multiple players play on one shared base, but this is not the classic game. What is needed is a classic game of solitaire which is multiplayer and provides a casino-like experience.

The present invention addresses this need by providing a method and system for a game that allows players to play solitaire against each other while playing a classic game of solitaire, each player having their own classic layout. This layout may be exchanged a certain number of times, so the players have some control over the layout they use. The present invention also adds the incentive of monetary rewards for three different situations. Monetary awards are given to the player who has the lowest total cards, any player who wins a true solitaire with no cards remaining in a stack and tableau, and to the overall winners of a certain number of games, during a certain period of time, or when a lottery pool reaches a certain amount.

### SUMMARY OF THE INVENTION

In the present invention, a method, together with an associated system, is provided for playing card games requiring a plurality of players each playing on a plurality of foundations. The system includes a game server and a plurality of clients that are operatively connected using the internet or any other communications network. The game server is comprised of computer hardware and software having at least one processor. The game server controls and manages functions relating to card playing communications among the clients, as well as communication transfers and data between the server and the client or clients. Each of the clients has necessary hardware and software for displaying, controlling, and initiating card plays in the card games. Each client typically includes a computer which as processing and application program execution capability, which could include a smartphone or other hand held or mobile device, together with any needed peripheral devices such as a display screen and an input device such as a keyboard and mouse. Software is used to implement key aspects of the system. Such software is responsive to inputs by the players.

The present invention provides multiple opportunities for a player to win. The game consists of multiple players who have paid an entrance fee to the house being dealt hands of solitaire, each with their individual deck. Each player has the opportunity to play the layout that is dealt or to have the cards dealt again, up to an agreed upon number of times. Each player plays their own solitaire game and a count is kept of how many cards are left in each respective player's stack and tableau at the end of each hand. If a player has a true solitaire and no cards are left in their stack and tableau at the end of a hand, the player collects a sum from all other players. The cards in each player's stack and tableau are added up after a certain number of hands and the players collect money from and pay money to each other based on the total number of cards in the stacks and tableaus at the end of a game. A percentage of each true solitaire goes to the lottery pool. Players earn points for each game based on their rank in each game. After an agreed upon number of games, a certain amount of time, or a certain amount of money, the lottery pool is distributed to the players with the highest number of points.

### Advantages

Accordingly several advantages of one or more aspects are as follows: solitaire for a monetary reward has a unique way of allowing a player to decide which layout of a solitaire hand that the player will play, up to a predetermined number of layouts. This increases the control that a player has over a game. Solitaire for a monetary reward allows a player to have a casino-like experience from the player's home. Solitaire for a monetary reward offers three ways of winning money, keeping the players interested. Players can win money by having the lowest total cards, winning a true solitaire with no cards remaining in a stack and tableau, and winning a percentage or a flat amount out of a lottery pool.

### BRIEF DESCRIPTION OF THE DRAWINGS

FIG. 1 is an example of a layout of solitaire game for a monetary reward.

FIG. 2 is an example of the players of solitaire game for a monetary reward

FIG. 3A is a flow chart of an example of how a method for competitively playing solitaire for a monetary reward is played.

FIG. 3B is a continuation of the flow chart of an example of how a method for competitively playing solitaire for a monetary reward is played.

FIG. 3C is a continuation of the flow chart of an example of how a method for competitively playing solitaire for a monetary reward is played.

FIG. 3D is a continuation of the flow chart of an example of how a method for competitively playing solitaire for a monetary reward is played.

FIG. 4 is a schematic of a system for use with solitaire game for a monetary reward.

FIG. 5 shows an outline of a possible game with seven players and an award of one dollar per card, and ten dollars per true solitaire.

### DETAILED DESCRIPTION

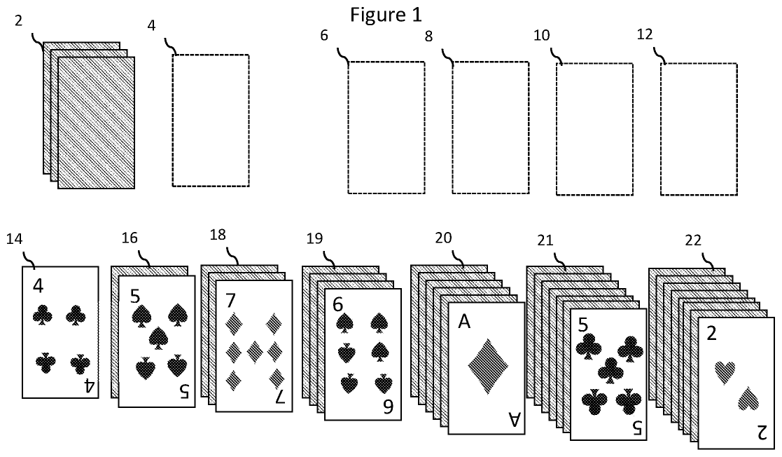

FIG. 1 shows an example of a layout of a standard solitaire hand. Solitaire is played with a standard 52 card deck. The game of solitaire, sometimes called Klondike Solitaire, is well known in the prior art. A layout is created by dealing cards in a row of columns with a top card in each column face up. A first column 14 consists of one card. A second column 16 consists of two cards. A third column 18 consists of three cards. A fourth column 19 consists of four cards. A fifth column 20 consists of five cards. A sixth column 21 consists of six cards. A seventh column 22 consists of seven cards. Column 14, column 16, column 18, column 19, column 20, column 21, and column 22 collectively are called a tableau. A remainder of the standard card deck is placed in a stack 2. A player places any aces in a foundation space, space 6, space 8, space 10, or space 12. For example, in FIG. 1, the ace in column 20 could be placed in space 6. After placing a card from one of the columns into the foundation space, a remaining top card in a column is turned over, and may be played. If there is no card left in a column, a King may be moved into a resulting space. If an ace is in space 6, space 8, space 10, or space 12, a number two card of a same suit may be placed on top of the ace. If a number two card is in space 6, space 8, space 10, or space 12, a number three card of the same suit may be placed on top of the number two card, and so on until space 6, space 8, space 10, and space 12 all contain king cards or there are no plays left. In the columns, a lower sequential number card can be placed on a higher sequential number card if they are of opposite colors. For example, in FIG. 1 the black six of spades in column 19 could be placed on the red seven of diamonds in column 18. Then the next top card in column 19 could be turned over.

The stack 2 would be turned over three cards at a time and placed in a space 4. Only a top card of the three that are turned over could be played on the columns or on space 6, space 8, space 10, or space 12. Play continues turning three cards over at a time until the stack 2 is empty then the stack is turned over, moved from space 4, and played again three cards at a time. Play continues until there are no more plays left or the space 6, space 8, space 10, and space 12 all contain king cards. When there are no plays left the cards in the stack 2 and the tableau, are counted and that is called a remainder score.

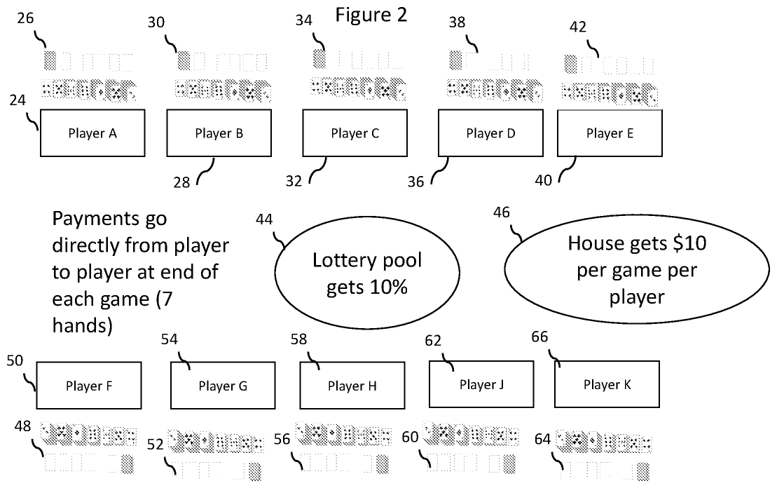

FIG. 2 shows an overview of a game of solitaire for monetary reward. In this example, ten players are playing on ten individual layouts. Player A 24 is playing on layout 26. Player B 28 is playing on layout 30. Player C 32 is playing on layout 34. Player D 36 is playing on layout 38. Player E 40 is playing on layout 42. Player F 50 is playing on layout 48. Player G 54 is playing on layout 52. Player J 62 is playing on layout 60. Player K 66 is playing on layout 64. The layouts each consist of a randomized deck of playing cards. When each player gets a layout, they can play that layout or pass and request another layout up to a set number of times. The lottery pool 44 gets a percentage of all monies won for having a true solitaire, in this example, ten percent. The house 46 gets a set fee per game played by each player, in this example the house gets ten dollars per game per player, or one hundred dollars. Payments go directly from player to player at the end of each game. In this example, one game is seven hands played.

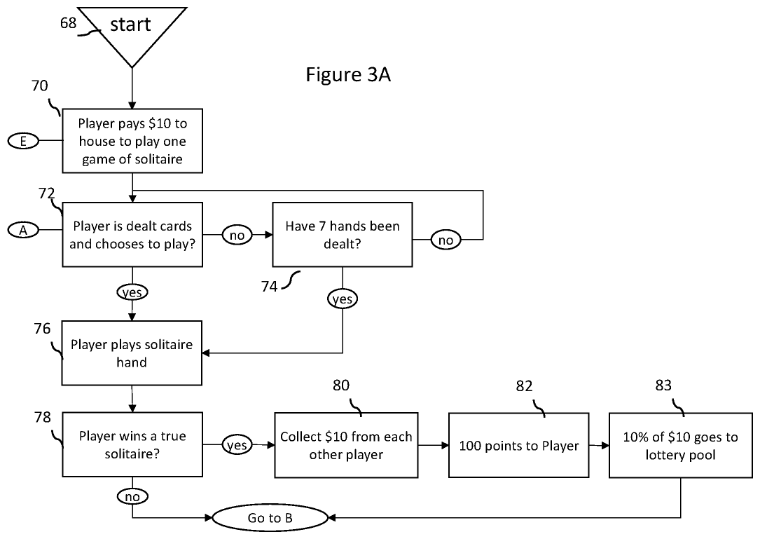

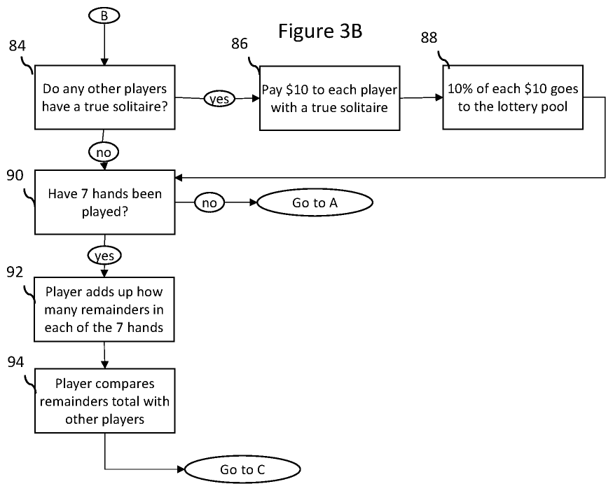

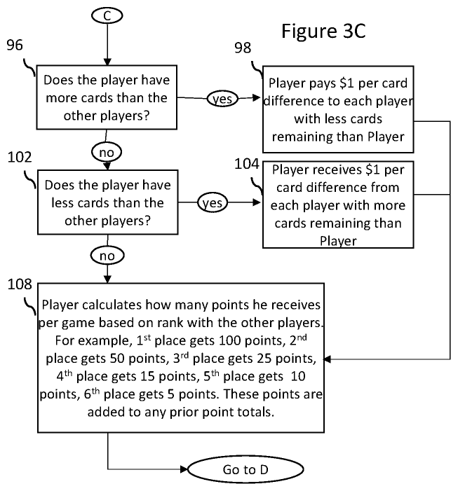

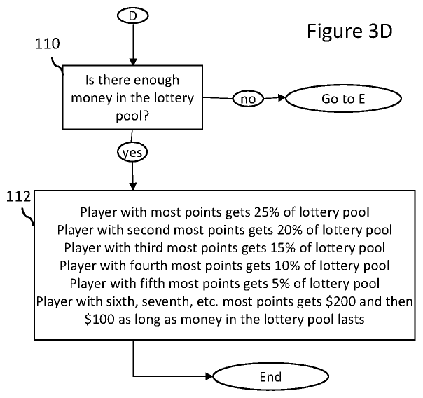

FIG. 3A, FIG. 3B, FIG. 3C, and FIG. 3D show a flow chart of the play of the invention from one player's point of view. In FIGS. 3A-3D a lottery pool is calculated during a hand, with each play. In FIG. 3A, start of play 68 is the beginning of the invention, a set number of games containing a set number of hands 70. Player pays a set fee to a house to play one game of solitaire, and each player pays the set fee. In this example, the set fee is ten dollars. Player is then dealt cards 72 and chooses whether to play a layout that is dealt. If the player doesn't want to play the layout as dealt, the Player can discard and have another layout dealt, up to a set number of times. In this example, the Player could pass on six layouts but would have to play a seventh layout as dealt. The Player plays a solitaire hand, as described in FIG. 1. If the Player has no remainder of cards in a stack and a tableau 78, then the player has won a true solitaire and can collect a percentage from every other player. In this example the player collects ninety percent of ten dollars from every other player. A remaining percentage goes to a lottery pool 83. In this example the remaining percentage is ten percent, and the lottery pool receives one dollar from each other player. The player also collects one hundred points for each true solitaire 82. If the player does have a remainder of cards in the stack and a tableau 78, then play goes to B on FIG. 3B.

In FIG. 3B, if any other players have a true solitaire, which means no remainder in their stack and tableau 84, then the player pays a percentage of an amount to each player that has a true solitaire. In this example, the player pays ninety percent of ten dollars, or nine dollars to each player with a true solitaire. The player also pays a percentage to the lottery pool for each player that has a true solitaire 88. In this example, the player pays ten percent of ten dollars, or one dollar to the lottery pool for each other player that has a true solitaire.

Play of a game continues for a set number of hands 90. In this example a game is seven hands. If seven hands have not been played yet then play continues from FIG. 3A where player is dealt cards and chooses to whether to play a hand 72. If seven hands have been played then that equals one game and Player adds up how many total remainders were in each of the seven hands. All of the players' total remainders are compared 94 one at a time. If the difference in the player's total remainder is greater than zero, then the player pays an amount of money per card difference to each player with less cards remaining than the player 98. In this example, the Player pays one dollar per card difference to each player with less cards remaining than the Player.

If the difference in total remainder is less than zero 102 then the Player receives a percentage of an amount per card difference multiplied by a factor from each player with more cards remaining than the Player 104. In this example, the Player receives one dollar per card difference from each player with more cards remaining than the Player.

The Player calculates how many points Player receives per game based on Player's rank with the other players 108. For example, in a game with seven players, first place could get 100 points, second place could get fifty points, third place could get twenty-five points, fourth place could get fifteen points, fifth place could get 10 points, and sixth place could get 5 points. These points are added to any prior point totals and play progresses to D in FIG. 3D.

In FIG. 3D, the game repeats until, for example, one hundred games have been played. The game could also repeat for a certain amount of time, for example one month, or until the lottery pool reaches a certain value, or until a certain number of points is reached by the highest scoring player. At this time, the players with the most points get a percentage of the lottery pool. For example, the player with the most points could receive twenty-five percent of the lottery pool, the player with the second most points could receive twenty percent of the lottery pool, the player with the third most points could receive fifteen percent of the lottery pool, the player with the fourth most points could receive ten percent of the lottery pool, and the player with the fifth most points could receive five percent of the lottery pool. Players in subsequent places could receive $200 or $100 as long as there is enough money in the lottery pool.

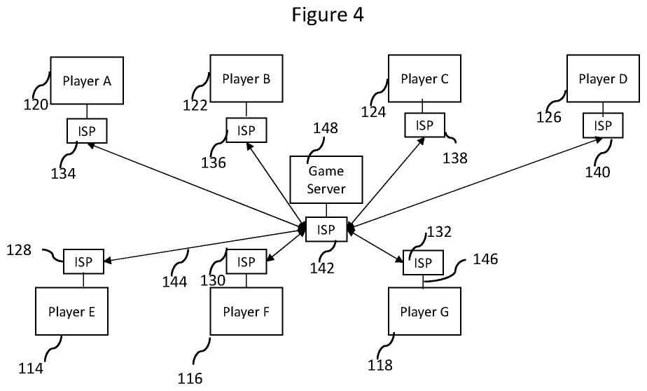

FIG. 4 shows a schematic of a system for use with a method of competitively playing solitaire for a monetary reward. Seven players are represented by Player A 120, Player B 122, Player C 124, Player D 126, Player E 114, Player F 116, and Player G 118. Each player plays on a computer, a smartphone or other handheld or mobile device, or any dedicated machine which includes a computer chip, hardware and software. The computer or other device for each Player is connected to a respective internet service provider (ISP), ISP 128, ISP 130, ISP 132, ISP 134, ISP 136, ISP 138, ISP 140 via a wifi or a hardwired local connection 146. A game server 148 is also provided which connects to an ISP 142 via wifi or a hardwired local connection. The game server 148 has overall control over playing the multiplayer solitaire game and distribution of any winnings to any players that may win any amount via credit card or online payment services such as paypal, zelle, venmo, and the like. The game server 148 connects 144 to the players via the internet and internet service providers. Each of the players has an address associated with it that the game server 148 uses in connection with communication transfers. The game server 148 also has an address that enables communications to reach the game server 148 from the players. The game server 148 includes hardware and software. The game server 148 is typically a multi-processing unit capable of handling a number of players as games are simultaneously played. The server software differs from players' software. While it is technically feasible to designate one of the players to run the server software along with the players' software, it is not desirable because if the player should log off or exit the network the game would be discontinued for the other players. Each player has identical software, and such software is typically obtained by download from the game server 148.

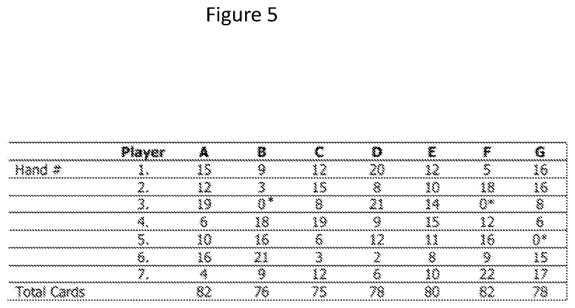

FIG. 5 shows an outline of a possible game with seven players and an award of one dollar per card, and ten dollars per true solitaire. Seven hands are played per game. In hand number one, player A has a remainder of fifteen cards, player B has a remainder of nine cards, player C has a remainder of twelve cards, player D has a remainder of twenty cards, player E has a remainder of twelve cards, player F has a remainder of five cards, and player G has a remainder of sixteen cards. The second hand is then played, and player A has a remainder of twelve cards, player B has a remainder of three cards, player C has a remainder of twelve cards, player D has a remainder of eight cards, player E has a remainder of ten cards, player F has a remainder of eighteen cards, and player G has a remainder of sixteen cards. The third hand is then played, and player A has a remainder of nineteen cards, player B has a true solitaire with a remainder of zero cards, player C has a remainder of eight cards, player D has a remainder of twenty-one cards, player E has a remainder of fourteen cards, player F has a true solitaire with a remainder of zero cards, and player G has a remainder of eight cards. Since player B has a true solitaire, player B collects ten dollars from each of players A, player C, player D, player E, player F, and player G. Since player F also has a true solitaire, player F collects ten dollars from each of player A, player B, player C, player D, player E, and player G.

Then hand four is dealt to and played by each player. Player A has a remainder of six, player B has a remainder of eighteen, player C has a remainder of nineteen, player D has a remainder of nine, player E has a remainder of fifteen, player F has a remainder of twelve, and player G has a remainder of 6. Hand five is then dealt to and played by each player. Player A has a remainder of ten, player B has a remainder of sixteen, player C has a remainder of six, player D has a remainder of twelve, player E has a remainder of eleven, player F has a remainder of sixteen, and player G has a true solitaire with a remainder of zero. Since player G has a true solitaire, player G collects ten dollars from player A, player B, player C, player D, player E, and player F. Hand six is then dealt and played and player A has a remainder of sixteen, player B has a remainder of twenty-one, player C has a remainder of three, player D has a remainder of two, player E has a remainder of eight, player F has a remainder of nine, and player G has a remainder of fifteen. The final hand, hand seven is then dealt and played and player A has a remainder of four, player B has a remainder of nine, player C has a remainder of twelve, player D has a remainder of six, player E has a remainder of ten, player F has a remainder of twenty-two, and player G has a remainder of seventeen.

In this example, there are seven hands played in a game, and the total remaining cards in all hands cumulatively are as follows: player A has eighty-two, player B has seventy-six, player C has seventy-five, player D has seventy-eight, player E has eighty, player F has eighty-two, and player G has seventy-eight.

Player C has the least amount of remaining cards with 75, so player B in second place with 76 pays player C one dollar (76-75). Player D and G are tied for third place with 78 cards, so player D pays player C three dollars (78-75), and player D pays player B two dollars (78-76). Player G also pays player C three dollars and player B two dollars. Player E is in fifth place with 80 cards, so player E pays player C five dollars (80-75), player E pays player B four dollars (80-76), player E pays player D two dollars (80-78), and player E pays player G two dollars (80-78). Players A and F are tied for sixth place with 82 cards, so players A and F each pay player C seven dollars (82-75), players A and F each pay player B six dollars (82-76), players A and F each pay player D four dollars (82-78), players A and F each pay player G four dollars (82-78), and players A and F each pay player E two dollars (82-80).

Calculating the lottery pool as in FIGS. 3A-3D, Player C wins twenty-six dollars. Player B wins twenty dollars, players D and G win ten dollars each. Player E wins four dollars. Player B pays one dollar, player D pays five dollars, player G pays five dollars, player E pays thirteen dollars, player A pays twenty-three dollars, and player F pays twenty-three dollars. Player C receives 100 points, player B receives fifty points, Players D and G each receive 15 points, Player E receives 10 points, and Players A and F each receive five points.

The true solitaire bonus is calculated during the game play. In hand three player F and player B have a true solitaire so they collect ten dollars each from players A, C, D, E, and G, $12 of which total goes to the lottery pool, leaving a remainder winnings of $44 each. In hand five G has a true solitaire so player G collects sixty dollars from players A, B, C, D, E, and F and of which $6 goes to the lottery pool. Players F, B, and G collect a net of $34 from the true solitaire bonus. Players A, C, D, and E each pay thirty dollars. A total of $18 goes to the lottery pool from the true solitaire bonus. Players F, B, and G each collect 100 points.

A lottery pool is collected over a period of time or a number of games, until a player reaches a certain point value, or until the lottery pool reaches a certain value. The period of time may be a month, or the number of games may be one hundred. In this example, the lottery pool reaches $10,000.00 and will be paid out as follows: first place in points gets twenty-five percent of the lottery pool, or $2,500.00; second place in points gets twenty percent of the lottery pool, or $2000.00; third place in points gets fifteen percent of the lottery pool, or $1500.00; fourth place in points gets ten percent of the lottery pool, or $10,000.00; fifth place in points gets five percent of the lottery pool, or $500.00; sixth through tenth place in points receive $200 per player; and eleventh through twenty-fifth place receive $100 per person.

Although there has been shown and described the preferred embodiments of the present invention, it will be readily apparent to those skilled in the art that modifications may be made thereto which do not exceed the scope of the appended claims. Therefore, the scope of the invention is only to be limited by the following claims.

I claim:

1. A method for playing a wagering game based on solitaire comprising the steps of:
Providing a plurality of players simultaneously playing a solitaire hand on randomized layouts each containing a stack of cards and a tableau,
Providing a number of cards being left in said stack of cards and said tableau for each player at an end of the solitaire hand,
Paying a certain amount of money per player to any player who has no cards left in the stack and tableau at the end of the solitaire hand,
Playing a certain number of hands per game,
Comparing said numbers of cards between players at an end of a game,
Awarding a player with a lowest number of cards in said stacks and tableaus a difference in number of cards multiplied by a factor by each of any other players.

2. The method from claim 1 wherein the players can reject a randomized layout up to a certain number of times and receive a new randomized layout.

3. The method of claim 1 wherein the players win points for no cards left in the stack and tableau of cards and for the amount of cards left in the stack and tableau of cards relative to the other players.

4. The method of claim 1 wherein the players pay a percentage of each win into a lottery pool which is distributed based on points earned after a criterion is met.

5. The method of claim 4 wherein the criterion is time related.

6. The method of claim 4 wherein the criterion is based on the number of games played.

7. The method of claim 4 wherein the criterion is based on the amount of money in the lottery pool.

8. A system for computerized playing of the method of claim 1 comprising a plurality of players' computers, said computers having memory, display means, and input means.
